SEQUENCE LISTING (4 sequences)

SEQ ID NO: 1 - DNA, 26 bp, Artificial Sequence
  Description of Artificial Sequencesynthetic DNA
caaaagcttatgaaaaactggaaaac

SEQ ID NO: 2 - DNA, 24 bp, Artificial Sequence
  Description of Artificial Sequencesynthetic DNA
tttggatccttacagcttagcgcc

SEQ ID NO: 3 - DNA, 22 bp, Artificial Sequence
  Description of Artificial Sequencesynthetic DNA
gacccgtgctaatatggaagac

SEQ ID NO: 4 - DNA, 22 bp, Artificial Sequence
  Description of Artificial Sequencesynthetic DNA
gtcttccatattagcacgggtc

(19) United States
(12) Patent Application Publication
(10) Pub. No.: US 2002/0114262 A1
(43) Pub. Date: Aug. 22, 2002

(54) Ocillation balance device

(76) Inventor: Lih-Hwa Kuo, Taipei (TW)

Correspondence Address: Rosenberg, Klein & Lee, Suite 101, 3458 Ellicott Center Drive, Ellicott City, MD, 21043, US

(21) Appl. No.: 09/754,315

(22) Filed: Jan. 5, 2001

(51) Int. Cl. G11B 23/00; G11B 25/00

(52) U.S. Cl. 369/264

(57) ABSTRACT

An oscillation balance device comprises a rotary body, at least one track and a plurality of rollers. The tracks are around a center of a rotary shaft of the rotary body. The tracks are installed on the rotary body. The plurality of rollers are formed by a plurality of first roller and a plurality of second rollers which have different friction coefficients. The first rollers and second rollers are arranged, alternatively. The friction force connected the first roller and the second roller is farther smaller than that between two second rollers. As a result, the sensitivity of the rollers to the unbalance of the system is improved. Therefore, the oscillations and noises are reduced and the precision in operation and lifetime are increased.

### FIELD OF THE INVENTION

The present invention is related to an oscillation balance device, and especially to a balance device suitable to a high speed optic disk drive, wherein Teflon or ceramic rollers are placed between two steel balls so as to reduce the friction force between two rollers.

### BACKGROUND OF THE INVENTION

In the application of high speed optic disk drive, the effect of unbalance weight distribution and high rotation speed induce that data can not be read and write normally, even faults occurs. However, as shown in FIGS. 1 and 2, in order to reduce the oscillation from the unbalance weight distribution of the disk 10a. An oscillation balance device is installed at the upper or lower end of the disk 10a in the optic disk drive 1a. The oscillation balance device 2a has a plurality of steel balls 20a as rollers in balance. The steel balls 20a are installed in a track 22a of a rotary body 21a. The rotary body 21a may be driven to rotate by a motor 11a. When the rotary speed of the rotary body 21a is higher than a threshold, the steel balls 20a rolls to a balance position according to the amount of unbalance weight distribution so as to achieve the object of reducing oscillations and noises.

However, generally, an oscillation balance device 2a has at least two steel balls 20a, otherwise, the steel ball 2a is itself a source of unbalance weight distribution so as to further increase the unbalance of the oscillation balance device and thus a greater oscillation occurs. Moreover, to increase the sensitivity to the unbalance of the system detected by the steel balls 20a, the oscillation balance device 2a will decrease the friction between the steel balls 20a and the track 22. However, the number of the steel balls 20a is not only 1, therefore, when the unbalance of the system is larger, most of the steel balls 20a are concentrated at one section and are contacted with each other. Furthermore, under the effect of the friction force of the steel balls 20a, the oscillation will be unstable.

Therefore, there is an eager demand for a novel oscillation balance device used in an optic disk drive for improving the defect in the prior art.

### SUMMARY OF THE INVENTION

Accordingly, the primary object of the present invention is to provide an oscillation balance device, wherein Teflon or ceramic rollers and steel balls are alternatively arranged. Every two steel balls are spaced by a roller for reducing the friction forces between two rollers. And the sensitivity of the unbalance is increased. Therefore, the oscillations and noises are reduced and the precision in operation and lifetime are increased.

To achieve the objects, the present invention provides an oscillation balance device comprises a rotary body, at least one track and a plurality of rollers. The tracks are around a center of a rotary shaft of the rotary body. The tracks are installed on the rotary body. The plurality of rollers are formed by a plurality of first roller and a plurality of second rollers which have different friction coefficients. The first rollers and second rollers are arranged, alternatively. The friction force connected the first roller and the second roller is farther smaller than that between two rollers. As a result, the sensitivity of the rollers to the unbalance of the system is improved. The various objects and advantages of the present invention will be more readily understood from the following detailed description when read in conjunction with the appended drawing.

### BRIEF DESCRIPTION OF THE DRAWINGS

FIG. 1 is an upper cross sectional view of a prior art oscillation balance device.

FIG. 2 is a lateral cross sectional view of a prior art oscillation balance device.

FIG. 3 is an upper cross sectional view of the oscillation balance device in the present invention.

FIG. 4 is a lateral cross sectional view of the oscillation balance device according to the present invention.

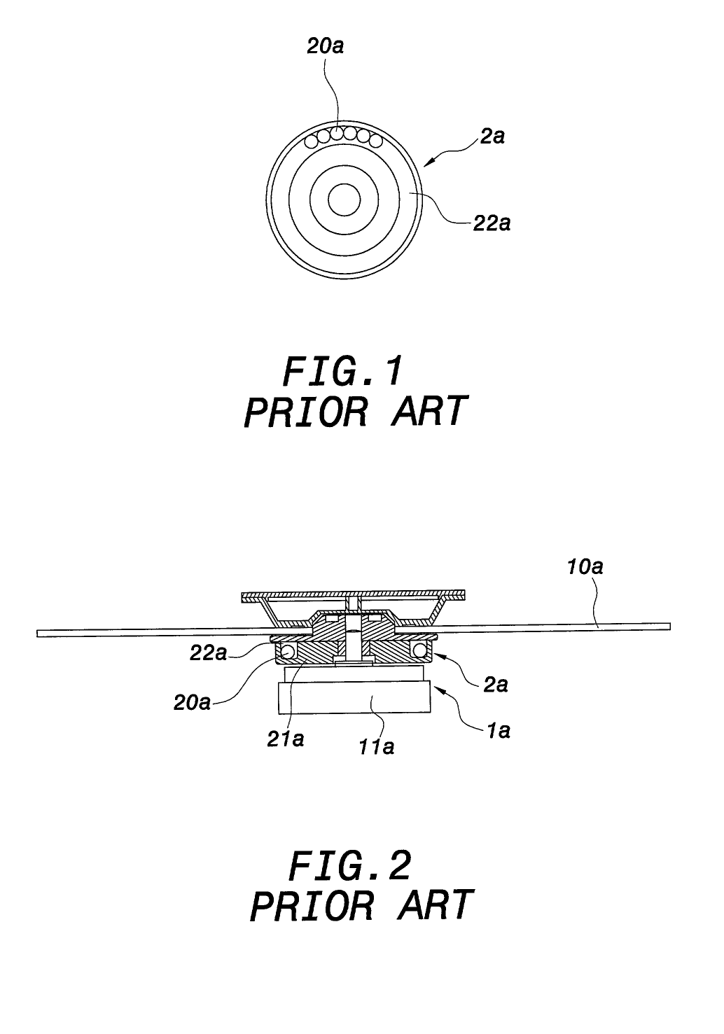

### DETAILED DESCRIPTION OF THE PREFERRED EMBODIMENTS

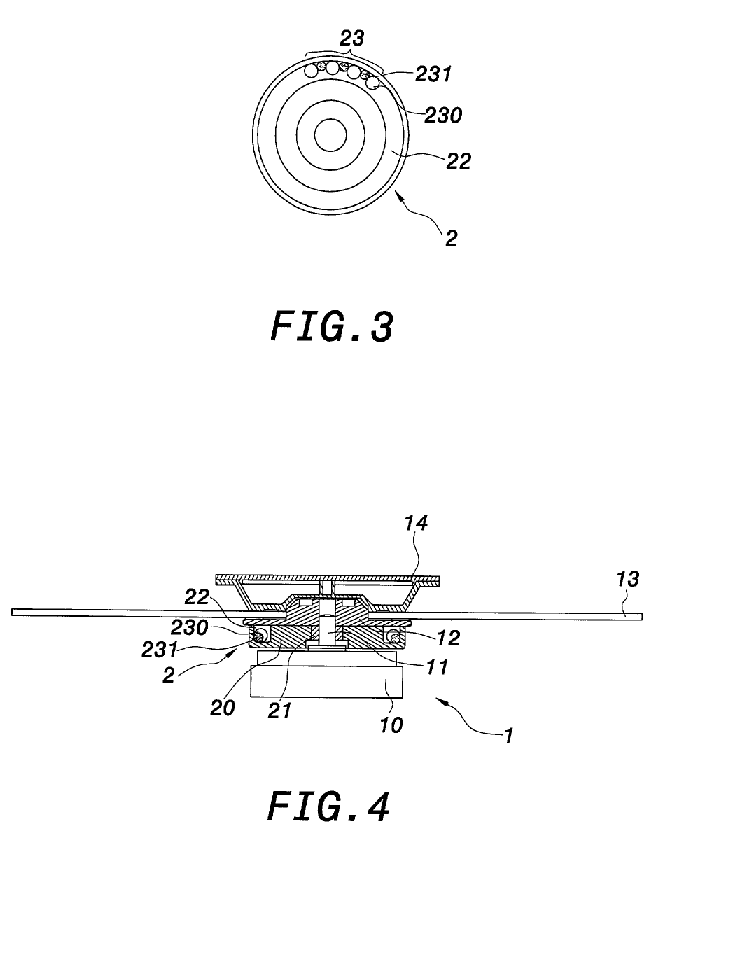

Referring to FIGS. 3 and 4, an optic disk reading and writing device 1 includes a spindle motor 10. The rotor 11 of the spindle motor 10 is connected to a disk supporting tray 12. The disk supporting tray 12 serves to support a disk 13. A disk pressing device 14 is installed above the disk supporting tray 12. The disk pressing device 14 presses on the disk 13. Thus, the disk supporting tray 12 and the disk pressing device 14 hold the disk 13. Then, the disk 13 is driven to rotate by the spindle motor 10. Thereby, the optic disk reading and writing device 1 may read and write data.

In the present invention, an oscillation balance device 2 is provided. The oscillation balance device is connected to the rotor 11 of the spindle motor 10 and the disk supporting tray 12. The oscillation balance device 2 has a rotary body 20. The rotary body 20 covers on the rotor 11 of the spindle motor 10. The rotary body 20 is installed with a round track 22 around the rotary axis 21 of the rotary body 20. The track 22 is a circular recess. The track 22 is installed on the rotary body 20. Further, the rotary body 20 may be installed with two or more tracks 22. The number of the tracks 22 is not confined. The cross sectional view of the track 22 may be a plane, an arc, a V shape, or others. A plurality of rollers 23 are installed on the track 22. The rollers 23 may have a shape of a ball, a round cylinder, a cone, and other round symmetrical shape. The rollers 23 are installed by a plurality of first roller 230s and a plurality of second rollers 231 which have different sizes, materials or friction coefficients. The material of the first roller 230 is steel. The material of the second roller 231 is Teflon or ceramic materials. The first rollers 230 and the second rollers 231 are arranged alternatively. The friction force connected the first roller 230 and the second roller 231 is farther smaller than that between two second rollers 23 1. Therefore, the sensitivity of the rollers 23 to the unbalance of the system is improved. When the rotary speed of the rotary body 20 is higher than a threshold. The rollers 23 rolls automatically to a balance position with the unbalance of the weight distribution. Therefore, the oscillations and noises are reduced and the precision in operation and lifetime are increased.

In summary, in the present invention, rollers of different friction coefficients are arranged alternatively so as to the sensitivity of the rollers to the unbalance of the system is improved. Therefore, the oscillations and noises are reduced and the precision in operation and lifetime are increased.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An oscillation balance device comprising:
a rotary body;
at least one track around a center of a rotary shaft of the rotary body; the track being installed on the rotary body; and
a plurality of rollers being formed by a plurality of first rollers and a plurality of second rollers which have different friction coefficients; the first rollers and second rollers being arranged alternatively; the friction force connected the first roller and the second roller being farther smaller than that between two second rollers.

2. The oscillation balance device as claimed in claim 1, wherein the rotary body is fixed on a spindle motor, and the rotary body is driven to rotate by the spindle motor.

3. The oscillation balance device as claimed in claim 1, wherein the first roller is made of steel, and the second roller is made of Teflon or ceramic materials.
